(19) United States
(12) Patent Application Publication
(10) Pub. No.: US 2014/0335398 A1
(43) Pub. Date: Nov. 13, 2014

(54) DEVICE AND METHOD TO PREVENT CELL-TO-CELL THERMAL RUNAWAY PROPAGATION IN A BATTERY PACK

(71) Applicant: BOSTON-POWER, INC., Westborough, MA (US)

(72) Inventors: Phillip E. Partin, Grafton, MA (US); Eric J. Carlson, Sudbury, MA (US)

(73) Assignee: BOSTON-POWER, INC., Westborough, MA (US)

(21) Appl. No.: 14/271,774

(22) Filed: May 7, 2014

Related U.S. Application Data
(60) Provisional application No. 61/820,468, filed on May 7, 2013.

(51) Int. Cl. H01M 2/10

(52) U.S. Cl. CPC H01M 2/1094
USPC 429/156

(57) ABSTRACT

A battery block includes a first prismatic battery cell defining a first substantially planar surface, a second prismatic battery cell defining a second substantially planar surface, the second substantially planar surface being in opposing relation to the first substantially planar surface, and a thermal barrier suspended between the first and second substantially planar surfaces, wherein the thermal barrier is spaced from both the first and second substantially planar surfaces.

### RELATED APPLICATION

This application claims the benefit of U.S. Provisional Application No. 61/820,468, filed on May 7, 2013. The entire teachings of this application are incorporated herein by reference.

### BACKGROUND OF THE INVENTION

Multi-cell battery blocks (cells in parallel and/or in series) and battery packs (blocks in parallel and/or in series) are susceptible to propagation of individual cell failures. For lithium-ion batteries, if one cell goes into thermal runaway (i.e. due to internal fault or exposure to out-of-specification or abuse conditions) the cell typically heats to levels sufficient to then propagate the failure to adjacent cells via thermal transfer of heat energy through direct and indirect contact between cells. This cell-to-cell propagation of failures can eventually cascade to all cells in the battery block or pack. This cell-to-cell propagation is more likely to occur with prismatic cells as they tend to be constructed of materials that allow for the expansion and contraction of the cell surfaces during normal charge and discharge cycles, and the cell's planar surfaces tend to expand during a cell runaway event. To effectively achieve a design that does not allow propagation of cell thermal runaway failures typically requires a large amount of spacing between cells, thus creating a larger battery pack, or a large amount of mass of a non-thermally or thermally conducting material surrounding each cell, thus creating a heavier battery pack. Since high volumetric and gravimetric energy density are critical requirements for battery packs, adding volume or weight has a negative impact on performance and can result in an unacceptable battery solution for a given application. Some of these materials can also impede air flow which will inhibit the convective cooling of the cells needed for proper thermal management.

Therefore, there is a need for an improved method of preventing cell-to-cell propagation of failures.

### SUMMARY OF THE INVENTION

The invention is generally directed to a battery block having a thermal barrier inserted between cells to reduce heat conduction between a failing cell and the adjacent cells, thereby preventing propagation of the initial failure. In one embodiment, a battery block includes a first prismatic battery cell defining a first substantially planar surface, a second prismatic battery cell defining a second substantially planar surface, the second substantially planar surface being in opposing relation to the first substantially planar surface, and a thermal barrier suspended between the first and second substantially planar surfaces, wherein the thermal barrier is spaced from both the first and second substantially planar surfaces. The thermal barrier defines a first end and a second end opposite the first end. The thermal barrier can have a thickness in a range of between about 0.3 mm and about 1.6 mm. The battery block can further include a supporting spacer at each of the opposing ends of the thermal barrier that separates the first and second substantially planar surfaces and suspends the thermal barrier therebetween. The supporting spacer can be a flexible supporting spacer. In some embodiments, the supporting spacers can adhere to at least one of the first and second substantially planar surfaces. The battery block can further include a housing that supports the batteries of the battery block. The thermal barrier can cover a surface area in a range of between about 60% and about 100% of the surface area of the opposing first and second substantially planar surfaces. The thermal barrier can include, for example, a ceramic fiber material or a polymeric material, such as a meta-aramid polymeric material. The thermal barrier including ceramic fiber material can have a thickness such as about 0.8 mm or about 1.6 mm. The thermal barrier including meta-aramid polymeric material can have a thickness such as about 0.3 mm, about 0.5 mm, or about 0.8 mm.

This invention has many advantages, such as preventing cell thermal runaway propagation after one or more cells in a battery block experiences a thermal event without significantly impacting the energy density of the battery block.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is an illustration of a battery block including a thermal barrier according to this invention.

FIG. 2 is a perspective view of the first or second substantially planar surface of a prismatic cell.

FIG. 3A is an end view of a battery block including thermal barriers according to this invention.

FIG. 3B is a section view along A-A shown in FIG. 3A of a battery block including thermal barriers according to this invention.

FIG. 3C is a side view of a battery block including thermal barriers according to this invention.

FIG. 3D is a plan view of a section taken along B-B shown in FIG. 3C of a battery block including thermal barriers according to this invention.

FIG. 4 is an illustration of a nail used to induce failure of a prismatic cell for testing of a battery block including thermal barriers according to this invention.

FIG. 5 is an illustration of prismatic cells of a battery block including thermal barriers according to this invention.

FIG. 6 is an illustration of a test stand for testing of a battery block including thermal barriers according to this invention.

FIG. 7 is a plot of maximum cell temperature for several thermal barrier materials according to this invention.

### DETAILED DESCRIPTION OF THE INVENTION

A description of example embodiments of the invention follows.

Battery blocks are generally desired to have as high an energy density as possible, and so cells will be positioned very close to each other. Typically, cells will be positioned either in contact with each other, or in sufficient proximity to each other such that, during a thermal runaway, failure of one cell will expand to neighboring cells, thereby causing cell failure to propagate to neighboring cells to enable the propagation of the failure to adjacent cells. In some pack designs, the problem of propagation can be exacerbated by the presence of thermally conductive pack packaging material between adjacent cells.

The invention is generally directed to a battery block having a thermal barrier suspended between cells to reduce heat conduction between the failing cell and the adjacent cells, thereby minimizing or eliminating the chance that failure of a cell will propagate thermally to adjacent cells in a battery block. The method described herein also minimizes or eliminates cell thermal runaway propagation without significantly impacting the battery block energy density or assembly cost.

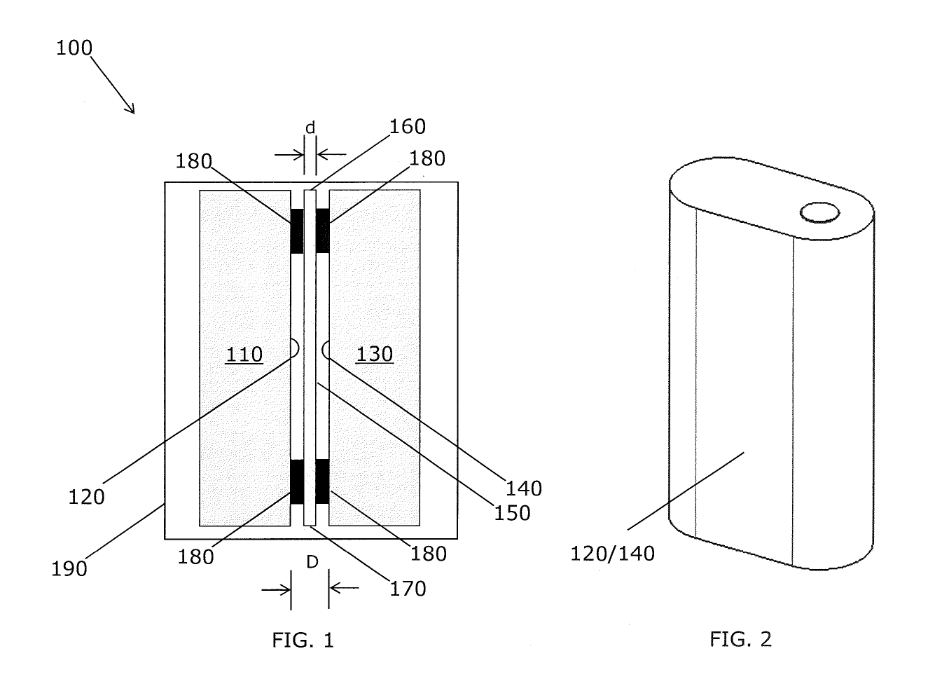

As used herein, a battery block is a parallel and/or series array of prismatic cells. In one embodiment shown in FIG. 1, battery block 100 includes first prismatic battery cell 110, said first prismatic battery cell 110 defining first substantially planar surface 120, second prismatic battery cell 130, said second prismatic battery cell defining second substantially planar surface 140, second substantially planar surface 140 being in opposing relation to first substantially planar surface 120, and thermal barrier 150 suspended between first 120 and second 140 substantially planar surfaces, wherein thermal barrier 150 is spaced from both first 120 and 140 second substantially planar surfaces. The first 120 or second 140 substantially planar surface is also shown in FIG. 2. Turning back to FIG. 1, thermal barrier 150 defines first end 160 and second end 170 opposite first end 160. The thickness “d” of thermal barrier 150 is sufficient to minimize or eliminate the likelihood of thermal propagation of cell failure from one of cell 110, 130 to the other cell 110, 130, and will depend upon the batteries, the material of the thermal barrier, and the distance between the batteries and the thermal barrier. The thickness d of thermal barrier 150 can be, for example, in a range of between about 0.3 mm and about 1.6 mm, such as about 0.4 mm, about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, or about 1.5 mm. Thermal barrier 150 is formed of a suitable material to reduce convection or conduction of heat from one of cell 110, 130 to the other cell 110, 130. Thermal barrier 150 can include, for example, a ceramic fiber material, such as a ceramic fiber paper made by AGIS (Ambler, Pa.), fiberglass fabric, or a polymeric material, such as a meta-aramid polymeric material. In one embodiment, thermal barrier 150 includes a woven fabric of meta-aramid fiber or meta-aramid fiber blended with para-aramid, antistatic or other synthetic fibers made by DuPont™ under the tradename NOMEX®. Other thermally insulating materials can also be used if they have similar characteristics, such as similar structural stability to resist sagging or melting at high temperature (e.g., greater than about 300° C.), and similar fire resistance.

Battery block 100 can further include supporting spacers 180 at each of opposing ends 160 and 170 of thermal barrier 150 that separates first 120 and second 140 substantially planar surfaces and suspend thermal barrier 150 therebetween. The thickness of supporting spacers 180 typically are in a range of between about 0.1 mm and about 0.3 mm, such as about 0.15 mm, about 0.2 mm, or about 0.25 mm.

The spacing “D” between surfaces 120 and 140 is sufficient to minimize or eliminate the likelihood of thermal propagation of cell failure from one of cell 110, 130 to the other cell 110, 130, and will depend upon the batteries, the material of the thermal barrier, and the distance between the batteries and the thermal barrier. The spacing D between surfaces 120 and 140 can be, for example, in a range of between about 2 mm and about 3 mm, such as about 2.1 mm, about 2.2 mm, about 2.3 mm, about 2.4 mm, about 2.5 mm, about 2.6 mm, about 2.7 mm, about 2.8 mm, or about 2.9 mm. Supporting spacers 180 generally are sufficiently flexible to substantially follow the contours of substantially planar surfaces 120, 140. In some embodiments, supporting spacers 180 adhere to at least one of the first 120 and second 140 substantially planar surfaces. An example of a suitable spacer 180 is adhesive tape, such as foam tape, for example very high bond (VHB) foam tape made by 3M (Minneapolis, Minn.). Typically, the adhesive tape has sufficient thermal stability to hold the thermal barrier in position during a thermal event, and also an ability to bond well to cell insulating materials such as cell insulating wrapper which is composed of a PET plastic material.

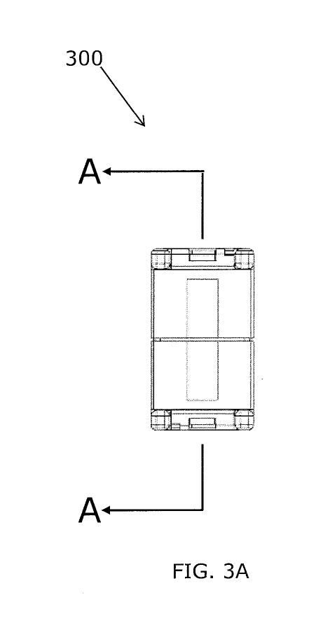

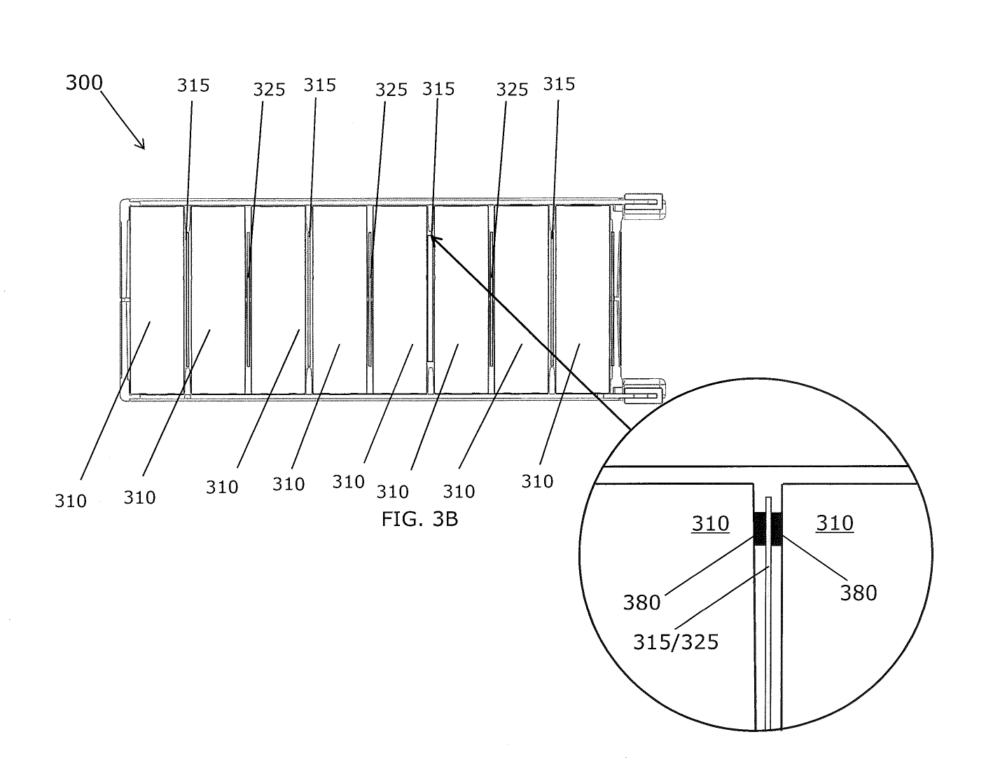

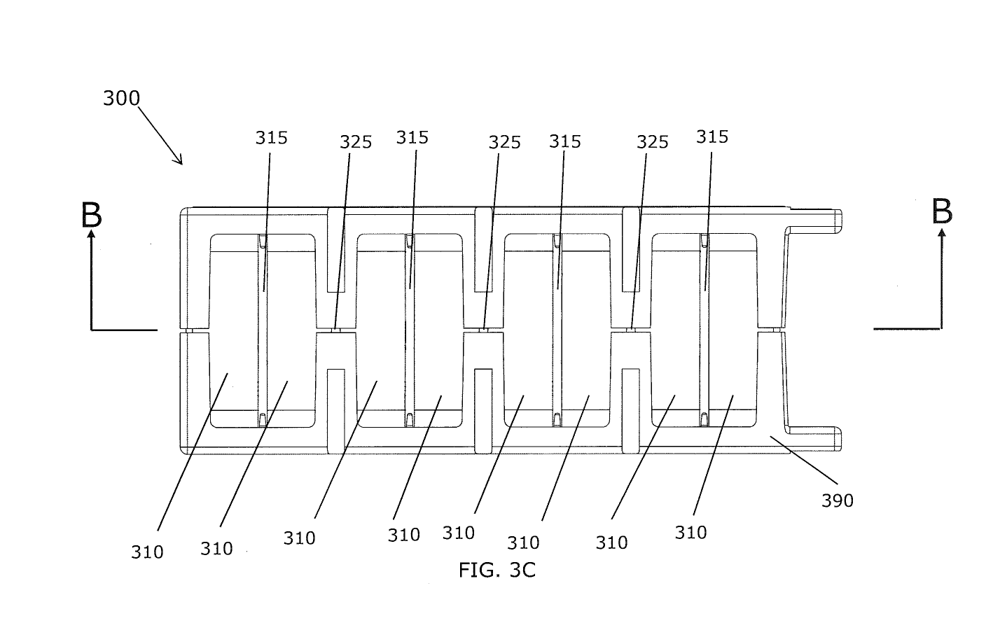

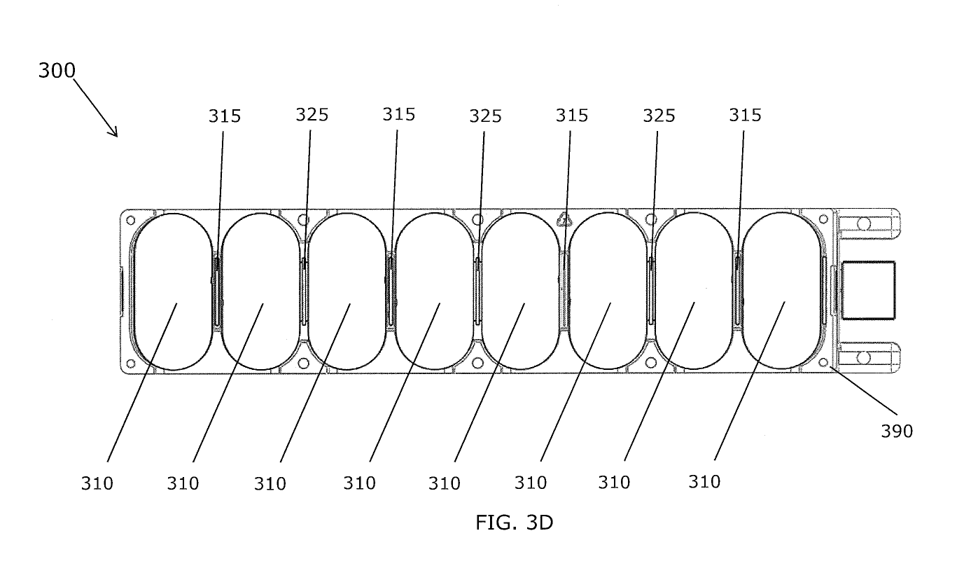

Battery block 100 can further include housing 190 that supports the batteries 110 and 130 of battery block 100. In various embodiments, thermal barrier 150 can cover at least about 60%, such as about 70%, about 80%, about 90%, or about 100% of the surface area of the opposing first 120 and second 140 substantially planar surfaces. FIG. 3A shows an end view of another embodiment of a battery block 300. A section view along A-A, shown in FIG. 3B shows eight cells 310, thermal barriers 315 and 325, and supporting spacers 380. FIG. 3C shows a side view of battery block 300, with portions of housing 390 hiding thermal barriers 325. Both thermal barriers 315 and 325 can be seen in FIG. 3D, which is a plan view of a section taken along B-B in the side view shown in FIG. 3C.

In another embodiment, a method to prevent cell-to-cell thermal runaway propagation in a battery block includes suspending a thermal barrier between a first substantially planar surface of a first prismatic battery cell and a second substantially planar surface of a second prismatic battery cell, wherein the thermal barrier is spaced from both the first and second substantially planar surfaces. The method can further include suspending a supporting spacer at each of a first end and a second end opposite the first end of the thermal barrier that separates the first and second substantially planar surfaces. The battery block, thermal barrier and supporting spacer are as described above. The thermal barrier should be applied to center it on the first or second substantially planar surface of the prismatic cell. In an exemplary embodiment, the method includes securing a tape insulator coupon alignment jig to a work table with double stick foam tape or screws, cutting VHB tape into four pieces about 125 mm in length, and loading seven insulator coupons into the insulator coupon alignment jig. The method then includes applying the VHB tape along the top edge of the insulator coupons, keeping the tape centered left-to-right, and repeating the tape application along the bottom edge of the insulator coupons. The method then further includes flipping the coupons over and realigning the insulator coupons in the insulator coupon alignment jig, followed by repeating the tape application on the rear side of the insulator coupons at the top and bottom edges, keeping the tape centered left to right. Then the method includes removing the clear protective film from top and bottom VHB tapes only on the front side of the insulator coupons, and cutting the top and bottom tapes between each insulator coupon. Installing the insulator coupons on cells includes placing a coupon face up (side with the clear protective film removed facing up) in a cell coupon alignment jig, and placing a cell over the insulator coupon, such that the insulator coupon is centered on the substantially planar surface of the cell.

### Exemplification

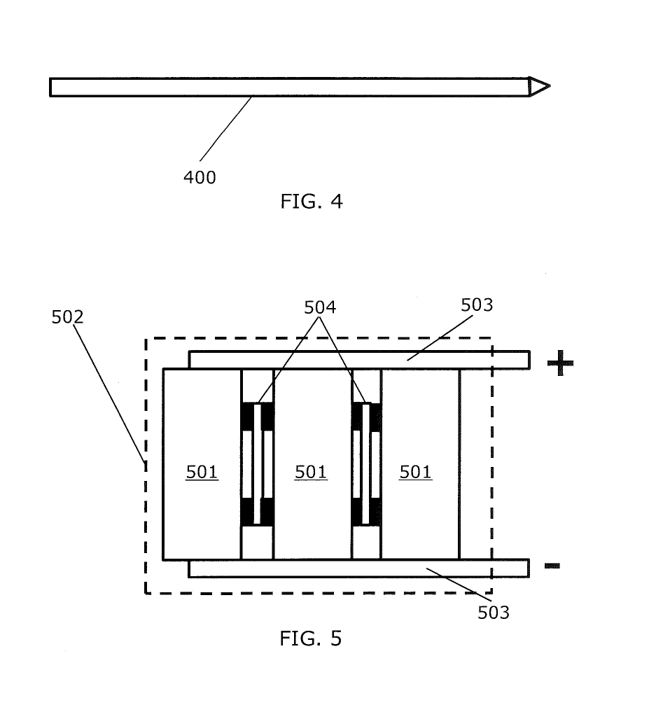

A test method was developed to provide data which was used to rate the effectiveness of various insulating materials. The first step was to create a test scenario that would reliably initiate thermal runaway in a prismatic lithium ion cell. The initiation of thermal runaway was accomplished by forcing a conductive, hardened, machined steel nail through a fully charged prismatic lithium ion cell. The prismatic cell tested was a 5300 mAh cell in an 18×37×65 oblong prismatic case (trade name Swing® 5300). As shown in FIG. 4 each test nail 400 was approximately 3 mm in diameter and 100 mm in length to insure complete penetration through the test cell. One end of the nail was machined into a shape to form a 45 degree cone. The nail was driven by a hydraulic cylinder with enough force to insure a continuous velocity of 40 mm/second. A new nail was used for each test to insure test repeatability as residues on the nail from the previous test could introduce unwanted variability in subsequent tests.

As shown in FIG. 5, the test sample consisted of three parallel prismatic cells 501 in a plastic housing 502 electrically connected in parallel with properly sized copper bus bars 503 to insure sufficient current flow between the cells when one of the cells was short circuited by the nail penetration. The potential thermal barrier material 504 was cut into rectangles approximately 16 mm by 46 mm and suspended between each pair of cells by strips of adhesive foam tape as described above.

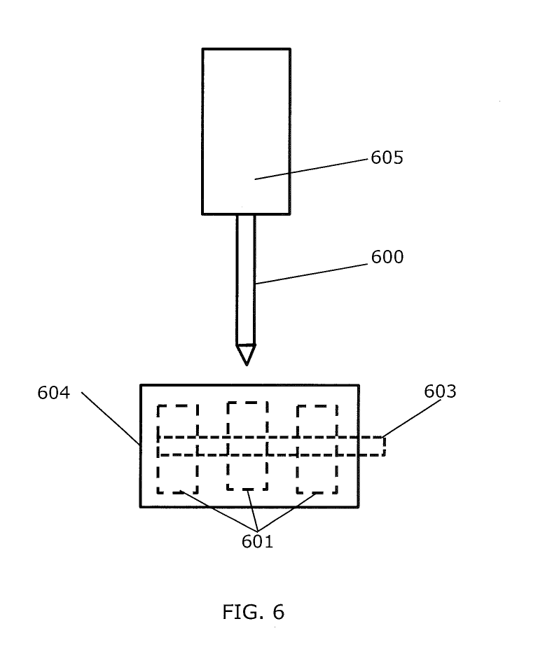

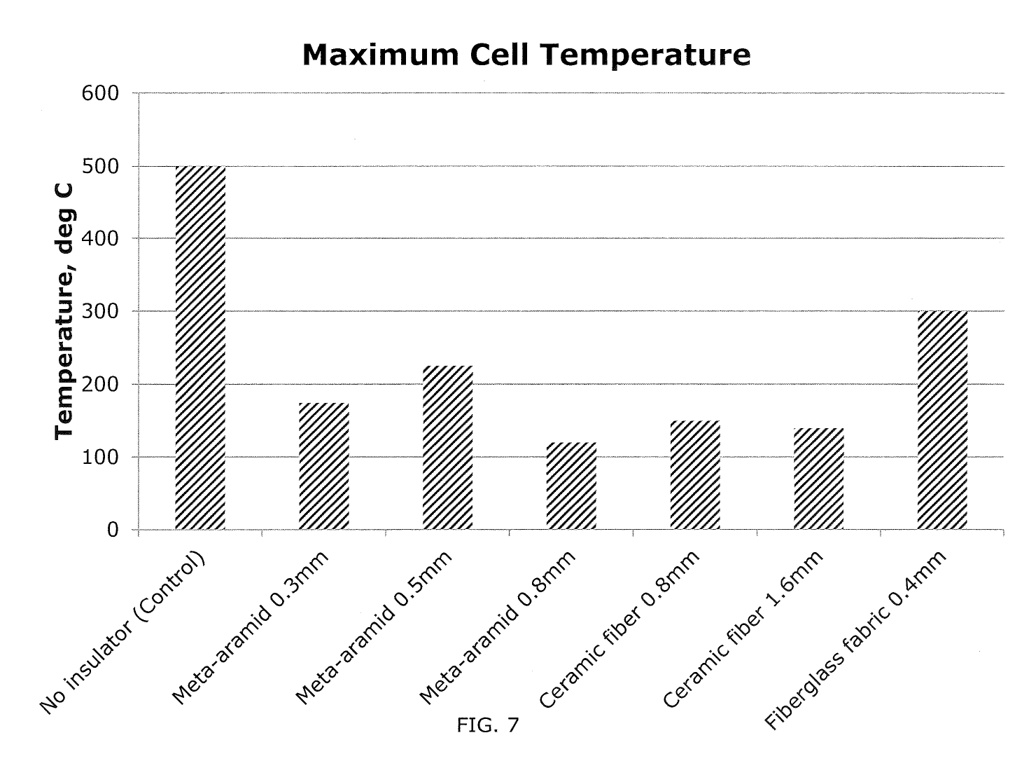

The test setup as shown in FIG. 6 consisted of a test stand 604 to hold three-cell test block 601 securely and the hydraulic cylinder 605 and nail 600 were mounted above the block with the nail aligned with the center cell as shown in FIG. 6. All three cells 601 were instrumented with thermocouples to monitor each cell temperature. The voltage of the block was also monitored at bus bar 603 along with the cell temperatures, using a data acquisition system and sampled at a data rate of 0.5 sec/sample. The data acquisition system was initialized to record data, and then the hydraulic cylinder was activated, driving the nail through the center cell. The test was repeated on three samples to improve confidence in the results. The evaluation criteria consisted of two metrics: 1) did thermal runaway propagate to an adjacent cell and 2), the maximum temperature recorded by the adjacent cells. If an adjacent cell experienced a thermal runaway event, then the test was recorded as a failure. For test configurations where the adjacent cells did not experience a thermal runaway, the test configurations with lower adjacent cell maximum temperatures were considered to be better. In addition to a Control with no thermal barrier, six insulating materials were tested, and the results are summarized in Tables 1 and 2 and graph shown in FIG. 7. Several of the materials demonstrated significant improvement in reducing the number of propagation failures and reduced adjacent cell temperature. The 0.8 mm meta-aramid polymeric material performed the best with no propagation and with the lowest adjacent maximum cell temperature.

TABLE 1
Cell Temperature Test Results

| Material | Maximum Cell Temperature ° C. |
|---|---|
| No insulator (Control) | 500 |
| Meta-aramid 0.3 mm | 175 |
| Meta-aramid 0.5 mm | 225 |
| Meta-aramid 0.8 mm | 120 |
| Ceramic fiber 0.8 mm | 150 |
| Ceramic fiber 1.6 mm | 140 |
| Fiberglass fabric 0.4 mm | 300 |

TABLE 2
Propagation and Ranking Results

| | Number of Tests | |
|---|---|---|
| | Propagation to | Rank |
| Test Material | Adjacent Cell | (1 best) |
| Control (no insulator) | 3 of 3 | Reference |
| Meta-aramid polymeric material 0.3 mm | 0 of 3 | 1 |
| Meta-aramid polymeric material 0.5 mm | 1 of 3 | 2 |
| Meta-aramid polymeric material 0.8 mm | 0 of 3 | 1 |
| Ceramic fiber material 0.8 mm | 0 of 3 | 1 |
| Ceramic fiber material 1.6 mm | 0 of 3 | 1 |
| Fiberglass fabric material 0.4 mm | 2 of 3 | 3 |

The relevant teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A battery block, comprising:
a) a first prismatic battery cell defining a first substantially planar surface;
b) a second prismatic battery cell defining a second substantially planar surface, the second substantially planar surface being in opposing relation to the first substantially planar surface; and
c) a thermal barrier suspended between the first and second substantially planar surfaces, wherein the thermal barrier is spaced from both the first and second substantially planar surfaces.

2. The battery block of claim 1, wherein the thermal barrier has a thickness in a range of between about 0.3 mm and about 1.6 mm.

3. The battery block of claim 1, wherein the thermal barrier defines a first end and a second end opposite the first end, and wherein the battery block further includes a supporting spacer at each of the opposing ends of the thermal barrier that separates the first and second substantially planar surfaces and suspends the thermal barrier therebetween.

4. The battery block of claim 3, wherein the supporting spacer is a flexible supporting spacer.

5. The battery block of claim 3, wherein the supporting spacers adhere to at least one of the first and second substantially planar surfaces.

6. The battery block of claim 5, further including a housing that supports the batteries of the battery block.

7. The battery block of claim 6, wherein the thermal barrier covers at least about 60% of the surface area of the opposing first and second substantially planar surfaces.

8. The battery block of claim 7, wherein the thermal barrier covers about 100% of the surface area of the opposing first and second substantially planar surfaces.

9. The battery block of claim 7, wherein the thermal barrier includes a ceramic fiber material.

10. The battery block of claim 9, wherein the thermal barrier has a thickness of about 0.8 mm.

11. The battery block of claim 9, wherein the thermal barrier has a thickness of about 1.6 mm.

12. The battery block of claim 7, wherein the thermal barrier includes a polymeric material.

13. The battery block of claim 12, wherein the polymeric material is a meta-aramid polymeric material.

14. The battery block of claim 13, wherein the thermal barrier has a thickness of about 0.3 mm.

15. The battery block of claim 13, wherein the thermal barrier has a thickness of about 0.5 mm.

16. The battery block of claim 13, wherein the thermal barrier has a thickness of about 0.8 mm.
